(19) United States
(12) Patent Application Publication
(10) Pub. No.: US 2026/0321613 A1
(43) Pub. Date: Oct. 15, 2026

(54) SYSTEMS AND METHODS FOR CONDUCTIVE ADDITIVE FREE ANODES

(71) Applicant: A123 Systems LLC, Novi, MI (US)

(72) Inventors: Sen Gao, Silver Spring, MD (US); David Laughman, Acton, MA (US); Hyehee Kim, Woburn, MA (US); Lily Moloney, Waltham, MA (US)

(21) Appl. No.: 19/645,009

(22) Filed: Apr. 10, 2026

Related U.S. Application Data
(60) Provisional application No. 63/786,889, filed on Apr. 10, 2025.

(51) Int. Cl. H01M 4/38; H01M 10/0525; H01M 10/0562; H01M 10/0585

(52) U.S. Cl. CPC H01M 4/386; H01M 10/0525; H01M 10/0562; H01M 10/0585; H01M 2300/0068

(57) ABSTRACT

Systems and methods are provided a solid state lithium ion battery cell including an anode material layer, a separator layer and a cathode material layer. The anode material layer includes silicon nanoparticles having a diameter less than or equal to 200 nm, wherein a wt. % of the silicon nanoparticles is greater than or equal to 90% and the separator layer includes solid state electrolyte.

### CROSS-REFERENCE TO RELATED APPLICATIONS

The present application claims priority to U.S. Provisional Application No. 63/786,889 entitled “SYSTEMS AND METHODS FOR CONDUCTIVE ADDITIVE FREE ANODES” and filed on Apr. 10, 2025. The entire contents of the above listed application is hereby incorporated by reference for all purposes.

### FIELD

The present description relates generally to systems and methods for additive free anodes of a solid state lithium ion battery.

### BACKGROUND AND SUMMARY

Solid state lithium ion batteries including solid state electrolytes are desirable due, in part, to increased safety achieved by replacing highly flammable conventional liquid electrolytes with less violently reactive solid state electrolytes. However, replacing the liquid electrolyte with solid state electrolyte may introduce additional complications to maintain an ionically and/or electrically conductive network throughout the battery cell. Without liquid electrolyte, conventional solid state lithium ion battery electrode formulations include conductive carbon additives and solid state electrolyte particles in addition to binder and the electroactive material to establish electronic and ionic conductivity throughout the active electrode layer. Specifically, with respect to a silicon anode, electronically conductive additives are conventionally added due to the relatively low electronic conductivity of silicon. However, the additional solid state electrolyte may react with the electroactive material and degrade to produce undesirable insulating byproducts. Furthermore, the reactivity of the solid state electrolyte may be facilitated/ worsened by the presence of conducting carbon additives, thereby resulting in electrode degradation and poor cell performance. Additionally, additional non-electroactive material in an electrode formulation leads to decreased energy density and the use of the solid state electrolyte material demands dry room processing and electrode slurry formulations based on non-polar solvents and compatible binder materials. In some examples, the conductive carbon filler and solid electrolyte may be omitted from the electrode if the stack pressure of the solid state lithium ion battery is high (e.g., 50 Mpa). Battery cell structures which depend on high stack pressure are not tenable for practical applications where energy density specification includes contributions from cell fixturing assemblies.

The inventors herein have identified the above problems and have determined solutions to at least partially solve them. In one example, an anode material layer of a solid lithium ion battery comprises silicon nanoparticles having an average diameter of less than or equal to 200 nm and binder, wherein a wt.% of the silicon nanoparticles in the anode material layer is greater than or equal to 90%; a separator layer including solid state electrolyte; and a cathode material layer. The higher specific surface area of the silicon nanoparticles enables the silicon nanoparticles to better establish conductive networks throughout the bulk of the electrode, even without added carbon and solid state electrolyte on behalf of the relatively high intrinsic ionic and electronic conductivities of silicon based anode active materials, themselves. In this way, addition of carbon and solid state electrolyte to the anode may be omitted, thereby increasing an energy density and performance of the solid state li-ion battery.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic diagram of an all solid state lithium ion battery including a conductive additive-free nanosilicon anode material layer.

FIG. 2 shows a scanning electron microscope image of an exemplary embodiment of silicon nanoparticles.

FIG. 3 shows a schematic diagram of a network of silicon nanoparticles in a conductive additive-free nanosilicon anode material layer in a discharged state and a charged state.

FIG. 4 shows a flowchart of an example of a method for manufacturing a conductive additive-free nanosilicon anode material layer.

FIG. 5 shows a graph of resistivity as function of porosity for conductive additive-free silicon anode material layers comprising either micron- or nano-sized silicon.

FIG. 6 shows a chart of initial coulombic efficiency for full cells with silicon based anodes with different combination of carbon and or sulfide electrolyte.

FIG. 7 shows a chart of capacity retention at the 45 cycle for full cell based on silicon based anode with different combination of carbon and or sulfide electrolyte.

FIG. 8 shows a graph of capacity retention for full cells based on silicon based anode with different combination of carbon and or sulfide electrolyte.

### DETAILED DESCRIPTION

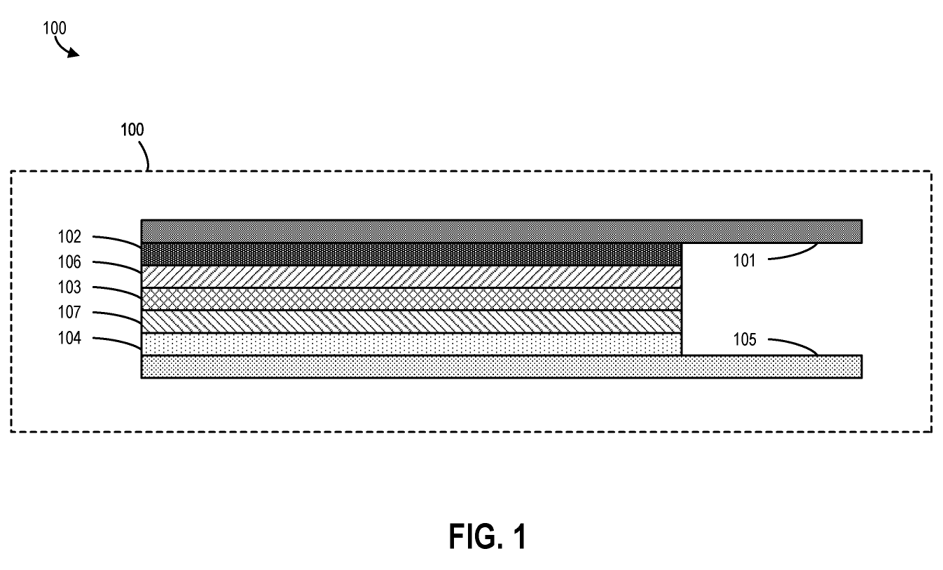

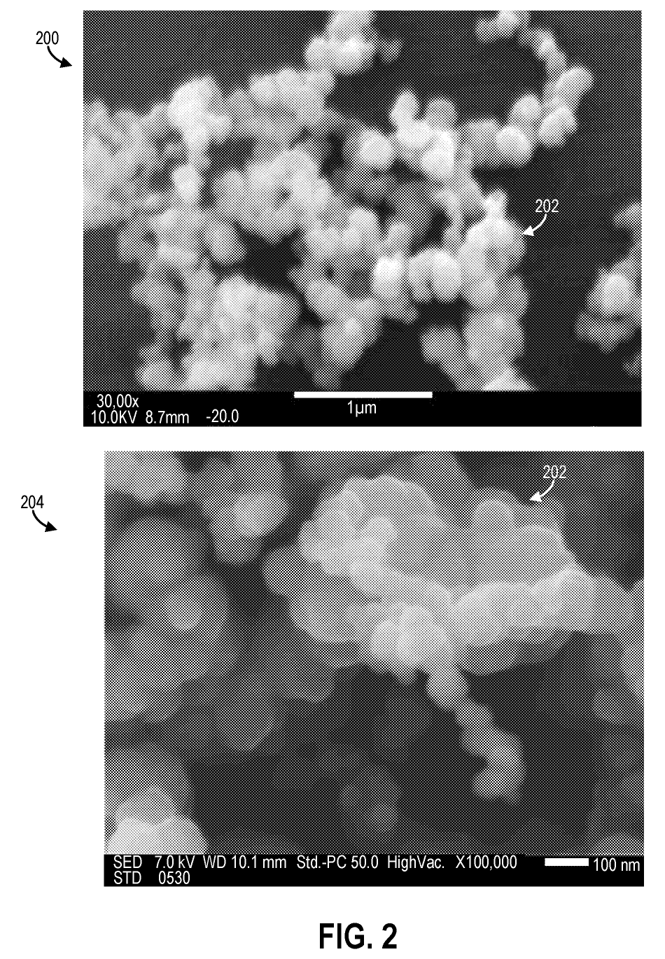

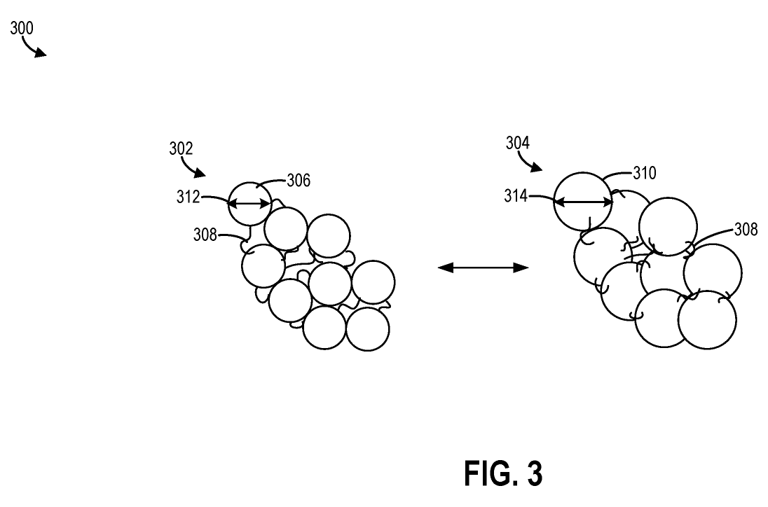

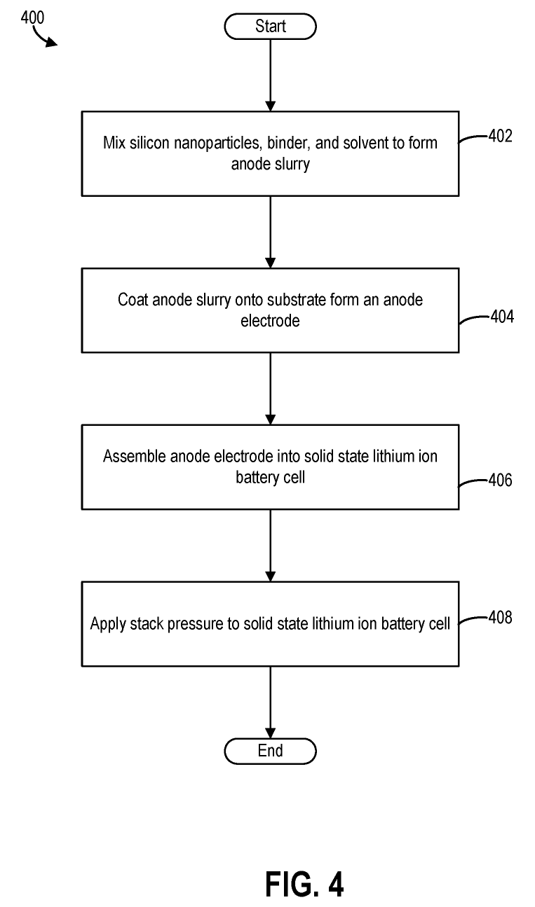

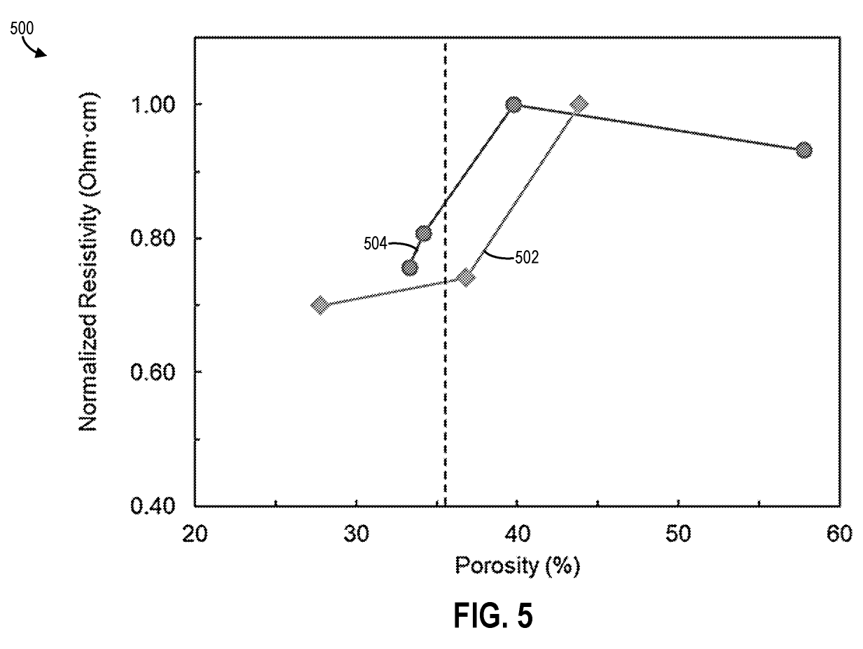

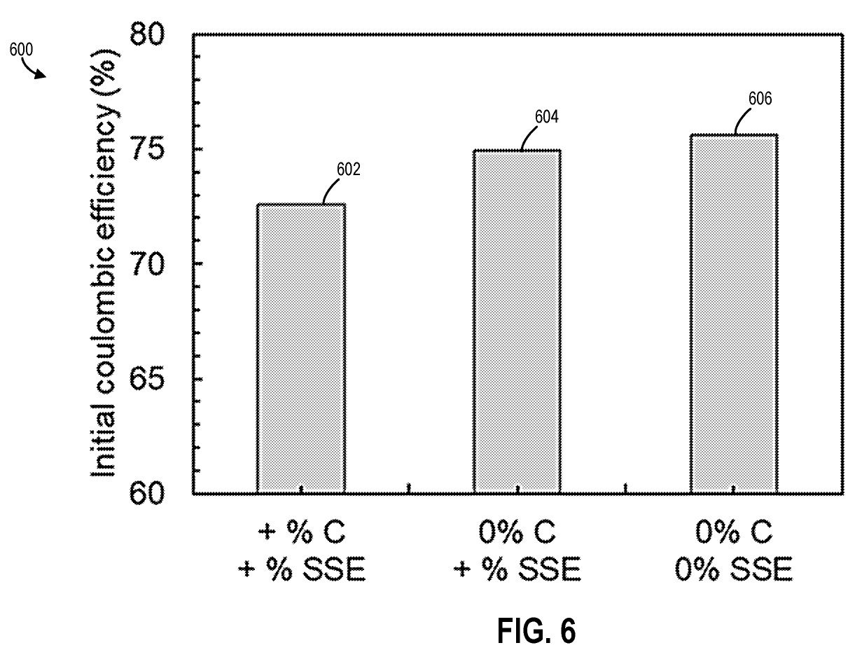

The following description relates to systems and methods for conductive additive-free anode material layers of solid state lithium ion batteries. A schematic example of a solid state lithium ion battery is shown in FIG. 1. The conductive additive-free anodes may comprise, consist of, or consist essentially of nanoparticles of silicon (e.g., nanosilicon) and a binder. Herein, nanoparticles may refer to roughly spherical particles. A diameter of the nanoparticles may be 250 nm or less. In some examples, the diameter of the nanoparticles may be in a range of from 50 nm to 250 nm. In further examples, the diameter of the nanoparticles may be less than or equal to 160 nm. In further examples the diameter of the nanoparticles may be less than or equal to 200 nm. A scanning electron microscopy (SEM) image of an example of silicon nanoparticles which may be included in the conductive carbon- and sulfide- additive free anodes is shown in FIG. 2. As shown schematically in FIG. 3, the respective size and volume of the silicon nanoparticles surprising enables conductive networks in both the discharged and charged states, even if conductive additives are not present. An example of a method for forming conductive additive-free anode material layers using silicon nanoparticles is shown in FIG. 4. Depending on a state of the anode material layer, the porosity of the anode material layer may vary. A graph of resistivity as a function of porosity of a conductive additive-free anode is compared in FIG. 5, demonstrating the contrasting response of porosity to resistivity for these two difference active materials’ designs. FIGS. 6-8 compare the performance attributes of full cells including a conductive additive-free nanosilicon anode material layer with full cells including a nanosilicon anode material layer including additional solid state electrolyte in combination with or absent the presence of carbon conducting additives.

Referring now to FIG. 1, an illustration of a non-limiting embodiment of an all solid state lithium ion battery (SS-LIB) cell sub-assembly (e.g., the battery cell) 100 is depicted. Sequentially, the battery cell 100 may include an anode current collector 101, an anode material layer 102, an anode separator interfacial layer 106, a separator layer 103, a cathode separator interfacial layer 107, a cathode material layer 104, and a cathode current collector 105. As such, the separator layer 103 may function as a battery separator. In some examples of the all solid state lithium ion battery cell sub-assembly 100, anode separator interfacial layer 106 and/or cathode separator interfacial layer 107 may be omitted. In further examples, multiple cathode separator interfacial coatings and/or anode separator interfacial coatings may be included.

One or more of the anode material layer 102 and the anode separator interfacial layer 106 may include an anode active material. As one example, the anode active material may be silicon nanoparticles. One or more of the cathode material layer 104 and the cathode separator interfacial layer 107 may include a cathode active material which contains lithium. In some examples the cathode active material particles may be lithium nickel cobalt manganese oxide (NCM) or other cathode active material species. In examples where the cathode active materials are NCM, the NCM may be high nickel NCM particles, having a nickel content greater than 60 molar % (e.g., NCM811, NCM622, NCM721, etc.). One or more of the separator layer 103, the cathode separator interfacial layer 107, and the cathode material layer 104 may include a sulfide-based electrolyte and polymer binder. The polymer binder may be electrically and ionically insulating. The sulfide-based electrolyte may be one or more of, but not limited to, Li₆PS₅Cl, Li₇P₃S₁₁, Li₅PS₄ClBr, and Li₃PS₄.

In some examples, the anode material layer 102 may include polymer binder and may not include sulfide-based electrolyte or conductive carbon materials. Further, the anode separator interfacial layer 106 may or may not include sulfide based electrolyte or conductive carbon materials. Herein, anode material layers or interfacial anode material layers may be referred to as being conductive additive-free anode material layers or interfacial anode material layers. A conductive additive may be a component such as carbon or solid state electrolyte which is ionically and/or electrically conducting but not an electroactive material. In other words, a conductive additive may not be oxidized or reduced during charging/discharging of the battery in a manner that substantially contributes to the reversible capacity of the battery that is exchanged between the electrodes during sustained operation. Further, conductive additive-free herein refers to lacking conductive additives at amounts which decrease resistivity of the electrode layer. As further examples, anode material layer 102 may be a conductive carbon free anode material layer and/or a solid electrolyte free anode material layer. The conductive carbon free anode material layer and solid electrolyte free anode material layers may not include conductive carbon or solid state electrolyte at concentrations which change electrical properties (e.g., increase conductivity or decrease resistivity of ions and/or electrons) of the anode material layer. For example, the anode material layer 102 may include only silicon nanoparticles and binder and does not include conductive carbon or solid electrolyte.

In some examples, an adhesion interface may be defined between the separator layer 103 and an electrode structure. The adhesion interface may be a three-dimensional interface between the separator layer 103 and the electrode structure, such that the separator layer 103 may conform to, and permeate into, a surface of the electrode structure. As a first example, the electrode structure may be the anode material layer 102 deposited on the anode current collector 101, optionally with the anode separator interfacial layer 106 deposited thereon. As a second example, the electrode structure may be the cathode material layer 104 deposited on the cathode current collector 105, optionally with the cathode separator interfacial layer 107 deposited thereon.

Turning now to FIG. 2, a first SEM image 200 and a second SEM image 204 are shown of silicon nanoparticles 202. Silicon nanoparticles 202 may be an example of silicon nanoparticles included in an anode material layer of a solid state lithium ion battery, such as anode material layer 102 of FIG. 1. In some examples, the silicon nanoparticles may have average diameters ranging from 50 to 250 nm as shown in first SEM image 200 and second SEM image 204. Further, the silicon nanoparticles 202 may be roughly spherical in shape. In some examples, the silicon nanoparticles may include a thin coating. In some examples, the coating may include doping or otherwise modifying a surface of the silicon nanoparticle. For example, a coating may completely and/or partially surround a surface of the silicon nanoparticles. For example, a coating may include, but is not limited to, one or more of polymer coating, carbon coating, inorganic material coating, and composites thereof. For example, an inorganic material coating may include a metal coating and/or a metal-oxide coating. The coating of the silicon nanoparticles may not be a conductive additive.

Additional types of silicon nanomaterials are also considered in the scope of the disclosure. Average size may be determined by laser diffraction particle size distribution or dynamic light scattering analysis. For example, an average diameter of the silicon nanoparticles may be less than or equal to 100 nm. In further examples, the average diameter may be less than or equal to 250 nm, less than or equal 200 nm, less than or equal to 160nm, or less than or equal to 100 nm. In some examples, the average diameter of the silicon nanoparticles may be less than or equal to 80 nm. In further examples, the average diameter of the silicon nanoparticles may be in a range of 20 nm up to 100 nm. In some examples, the average diameter of the silicon nanoparticles may be in a range of 50 nm up to 90 nm. In further examples the average diameter of the silicon nanoparticles may be in a range of 50 nm up to 100 nm. In some examples, the average diameter of the silicon nanoparticles may be in arrange of 60 nm up to 80 nm. In some examples, the average diameter of the silicon nanoparticles may be in a range of 70 nm up to 90 nm. In further examples, the average diameter may be in a range of from 50 nm to 250 nm or from 50 nm to 200 nm. In some examples, the average diameter may be in a range of from 50 nm to 160 nm. Further, other shapes of silicon nanoparticles are also considered in the scope of the disclosure. As one example, the silicon nanoparticles may be in the form of rods, discs, pyramids, or other polyhedral shapes. In some examples, the silicon nanoparticles may include a thin coating which surrounds or substantially completely surrounds a surface of the silicon nanoparticle. The thin coating may include, but is not limited to, one or more of graphite, carbon, inorganic material, and polymer. Inorganic material may include metals and/or metal oxides.

Turning now to FIG. 3, a schematic diagram 300 is shown including a discharged conductive additive-free nanosilicon anode material layer 302 and charged conductive additive-free nanosilicon anode material layer 304. Material layers 302 and 304 may be illustrations of nanoparticles in an anode material layer, such as anode material layer 102 of FIG. 1. Discharged conductive additive-free nanosilicon anode material layer 302 may include silicon nanoparticles 306 and binder 308. Binder 308 may be a non-conductive polymer and may help adhere silicon nanoparticles 306 to each other and to adjacent layers of the SS-LIB cell, such as the current collector and separator layer or anode interfacial layer. Silicon nanoparticles 306 may have an unalloyed diameter 312 when the anode is in a pristine discharged state. The unalloyed diameter 312 may be equivalent to the diameter of the pure silicon nanoparticles, such as the silicon nanoparticles 202 described above with respect to FIG. 2. Alloyed nanoparticles, as described further below, may remain in the anode in a non-pristine discharged state (e.g., discharged after charging). In this way, an average size of silicon nanoparticles in the non-pristine discharged anode may be larger than in the pristine discharged anode. The silicon nanoparticles 306 may arrange into a conductive network interspersed with binder 308. Having a large specific surface area, a surface of a silicon nanoparticle 306 may be highly likely to be in face sharing contact with a neighboring silicon nanoparticle, even when the SS-LIB is under moderate stack pressure.

Charged conductive additive-free nanosilicon anode material layer 304 may include Li-Si alloyed nanoparticles 310 interspersed with binder 308. Li-Si alloyed nanoparticles 310 may be an alloyed diameter 314. Alloyed diameter 314 may be larger than unalloyed diameter 312 forcing additional interfacial contact between the Li-Si alloyed nanoparticles 310. In this way, the silicon nanoparticles 306 may enable conductive networks in the discharged and charged states of the anode material layer, even without conductive additives such as additional solid state electrolyte and conductive carbon.

Turning now to FIG. 4, a flowchart of an example of a method 400 for forming a conductive additive-free nanosilicon anode and lithium ion battery cell therefrom is shown. Method 400 may be at least partially carried out using high volume/high throughput manufacturing systems such as slot-die coating and/or roll-to-roll processing.

At 402, method 400 includes mixing silicon nanoparticles, binder, and solvent to form an anode slurry. The mixing may include dispersing the silicon nanoparticles into a blend of the solvent and the binder. Dispersion of the nanosilicon powder is achieved by careful introduction of the silicon to the solvent and binder components of the slurry in a manner that preserves the targeted solids content of the final formulation. This may be achieved by use of such methods as sonication, bead milling, roller milling, basket milling, attritor milling, acoustic mixing, among others. Dispersion of the silicon can be achieved by first adding the silicon to a part of the total solvent package. The part of the total solvent package may include a portion of the binder comprising the final anode slurry formulation.

In some examples, the solvent may be divided into portions and mixing may include mixing in stages. In a first mixing stage, silicon nanoparticles may be dispersed in a first portion of solvent to form pre-dispersed nanoparticles. The first stage may include dispersion by, for example, high speed dispersion, milling or sonication. In a second mixing stage, binder may be dispersed in a second portion of solvent to form a pre-dispersed binder. In a third stage, the pre-dispersed binder may be gradually mixed into the pre-dispersed nanoparticles. In this way, a stable dispersion of silicon nanoparticles may be maintained. The first, second, and/or third stage may include mixing at a mixing speed in a range of from 1,500 to 30,000 rpm. In some examples, the mixing speed may start at a low end of the range and gradually increase to a higher end of the range during a mixing duration. In other examples, the speed may decrease throughout the course of mixing. A mixing duration may be in a range of from 3 minutes to 180 minutes.

In alternative examples, all materials may be combined in a single container and may be mixed together in a single stage. For example, silicon nanoparticles, solvent, and binder may be combined in a single container followed by mixing until components are homogeneously dispersed to form the anode slurry.

The anode slurry may comprise, consist of, or consist essentially of silicon nanoparticles, binder, and solvent. The anode slurry may be a conductive additive-free anode slurry. The conductive additive-free anode slurry may not include conductive additives at concentrations which increase a conductivity (e.g., either electrical or ionic conductivity) of the anode material layer formed from the anode slurry. A concentration of the conductive additives in the slurry may be zero. In some examples, the concentration of the conductive additives in the slurry may be less than 5 wt.%. In alternate examples, the concentration of the conductive additives in the slurry may be less than 2.5 wt.% The silicon nanoparticles may include the silicon nanoparticles described above with respect to FIG. 2. The binder may be a non-conductive polymer. The binder may not include conductive additives. The binder and solvent may be compatible with each other such that the binder is soluble in the solvent. As one example, the binder may be a fluoropolymer, polyether, polyester, carboxymethylcellulose, or combinations thereof. In further examples, the binder may be a polymer based on monomers of methyl methacrylate, acrylonitrile, styrene, butadiene, acrylic acid, or vinylidene fluoride, or combiantions thereof. For example, the binder may be one or more of styrene-butadiene-rubber, polyvinylidene fluoride, hydrogenated nitrile butadiene rubber, polyisobutene, ethylene-vinyl acetate, or combinations thereof among others

The solvent may be polar or non-polar and may be compatible with the binder and silicon nanoparticle surface functionalization. The solvent may be non-conductive and may not include conductive additives. For example, the solvent may be one or more of water, N-methyl-2-pyrrolidone, hexyl butyrate, hexyl acetate, anisole, xylene, octanol, and chlorobenzene among others. In some examples, the solvents and binders may be selected to be compatible based on matching dielectric constant values and/or matching Hansen Solubility Parameters (HSP).

As one example the solids of the anode slurry may be comprised of silicon nanoparticles at a wt. % in a range of 90% to 99%. In alternate examples, the silicon nanoparticles may be in a wt. % of 92% to 97%. In further examples the silicon nanoparticles may be in a range of 94% to 96%. In some examples, the solid wt. % of silicon nanoparticles may be greater than or equal to 95%. In some examples, the solid wt. % of silicon nanoparticles may be greater than or equal to 90%.

A silicon anode slurry solid contents may be in a range of 25 wt.% to 60 wt.% In further examples, a solids content of the slurry may be in a range of 18 wt. % to 40 wt.% In further examples, a solids content of the slurry may be in a range of 18 wt.% to 50 wt.% In further examples, a solids content of the anode slurry maybe in a range of 18 wt.% to 70 wt.%. A remainder of the solid wt. % of the anode slurry may be comprised of binder. For example, the wt. % of binder may be in a range of 1% to 10%. As a further example, the binder may be in a range of 3% to 8%. In further examples, the binder may be in a range of 4% to 6%. In some examples, the wt.% of binder may be a range of 0.5% to 10%. In some examples, the solid wt. % of binder may be 5%.

Mixing the silicon nanoparticles, binder, and solvent to form the anode slurry may occur under ambient atmosphere conditions. Ambient atmosphere conditions may include a humidity and oxygen abundance of a conventional manufacturing environment. Neither the silicon nanoparticles, binder, nor solvent may be particularly reactive towards air or oxygen. For this reason, mixing may not occur in a dry room or in any other specialized facilities demanded to control an amount of moisture and/or oxygen in the air.

At 404, method 400 includes coating the anode slurry onto a substrate to form an electrode (e.g., an anode). In one example, the substrate may be a current collector. In an alternative example, the substrate may be a separator or other neighboring layer of the solid state lithium ion battery. As one example, the coating may be draw-down coated on the current collector. Additional methods may include the use of slot die coating, tape casting, gravure coating, or spray deposition. The current collector may be conductive metal foil. As one example, the metal foil may include a layer of organic conductive material such as carbon on a surface. Additionally or alternatively, the current collector may include a layer of metallic material. The carbon and/or metallic layer on the surface may be interposed between the metal foil and the anode slurry. The carbon and/or metallic layer may remain at the interface between the metal foil and the anode slurry and may not be in the anode active material layer. The metal foil may be surface treated, roughened, or chemically treated to increase its surface area. In some examples the metal foil may be a copper foil. In further examples, a thickness of the metal foil may be approximately (e.g., +/- 5%) 12 micrometers, and comprise stainless steel, nickel, carbon felt or combinations thereof.

At 406, method 400 includes assembling the anode electrode into a solid state lithium ion battery cell, such as solid state lithium ion battery cell 100 of FIG. 1. Assembling may include further coating of layers of the SS-LIB, such as the separator and cathode layers. The further layers of the SS-LIB may include solid state electrolyte. As one example the solid state electrolyte may be a sulfide electrolyte. In alternate examples, the solid state electrolyte may additionally or alternatively be one or more of a polymer, oxide, or halide. The individual layers of the battery, including the anode, separator and cathode, may be combined by lamination processes which combine the layers using pressure and temperature to adhere the layers to form a structure comprising all three layers, as an example. Such a method can also be used to manufacture more complex structures, which repeat the above motif (e.g., as a bilayer or trilayer), or a similar structure based on double sided anode or cathode layers, and opposing separator and anode structures to create functioning electrochemical devices. In other examples, the solid state lithium ion battery cell may be assembled by coating sequential layers to form the desired structure. In further examples, a combination of sequential coating and lamination may be used to assembly the solid state lithium ion battery.

At 408, method 400 includes applying a stack pressure to the solid state lithium ion battery cell. The stack pressure may be a force applied normal to the anode and cathode current collectors and may help form and maintain physical and electrical contact between the components of the SS-LIB cell. As one example the stack pressure may be applied by normal to the SS-LIB cell by fixturing using a fixture or assembly, which is capable of maintaining a uniform pressure. As one example, the applied stack pressure may be less than 10 MPa. In further examples, the applied stack pressure may be in a range of 0.5 – 10 MPa. In some examples, the stack pressure may be in a range of 0.5 – 7 MPa. In some examples the stack pressure may be in a range of 0.5- 4 MPa. In further examples the stack pressure may be less than 5 MPa. In some examples the stack pressure may be less than or equal to 2 MPa. In some examples the stack pressure may be in a range of 0.5 – 2 MPa. Method 400 ends.

Turning now to FIG. 5, a graph 500 is shown of normalized resistivity of two conductive additive-free nanosilicon anode material layers, as a function of porosity in a delithiated state. Graph 500 compares anode material layers comprising either micron- or nano-silicon silicon powder based anode active materials. A plot 502 corresponds to resistivity of the conductive additive-free nanosilicon anode material layers as a function of porosity at different stages of densification. The nanosilicon anode material layer include silicon particles with diameters on the nanoscale. A plot 504 corresponds to resistivity of conductive additive-free microsilicon anode material layers as function of porosity at different stages of densification. Microscilion anode material layers include silicon particles with diameters on the micron scale. It can be seen that a lower porosity is demanded for micron-sized silicon to achieve a reduction in resistivity comparable to that of the nano-sized silicon, as an indication of the role the silicon’s particle size and surface area has on propensity to establish a percolative network throughout the electrode. The demand for reduced porosity values may reduce the electrode microstructure tolerance of state of charge induced volume changes, which the porous volume can help accommodate to avoid structural degradation. Porosities of the conductive additive-free nanosilicon anode material layer after coating and drying of solvent may be between 60% and 70%. Porosities of the nanosilicon anode may be between 25% and 60% following electrode densification methods in preparation for or as part of SS-LIB cell processing and assembly operations. Porosities of less than 50% are achieved by a combination of electrode densification and full SS-LIB cell lamination. By more aggressively laminating the full SS-LIB, porosity of the conductive additive-free nanosilicon anode may be further reduced to a range of 20% to 35%.

Full cells comprising NCM based cathode and nanosilicon based anodes were assembled including anodes comprising formulations including the silicon active materials and formulations where only the solid state electrolyte or the carbon and the solid state electrolyte components of the slurry are also present. Nanosilicon with an average diameter of 80nm was used to prepare the nanosilicon based anodes tested in FIGS. 6-8. A stack pressure of 2 MPa is applied to each full cell and testing was carried out at a temperature of 70°C. The cells were cycled between 4.15 and 1.5 V at a rate of C/20. Results of the tests of the full cells are discussed further below with respect to FIGS. 6-8.

Turning now to FIG. 6, a chart 600 is shown. Chart 600 includes columns with values shown along the y-axis corresponding to initial coulombic efficiency values of full cells comprising anode material layers of different compositions. A first column 602 corresponds to a first anode material layer including silicon nanoparticles, sulfide solid state electrolyte, and conductive carbon. A second column 604 corresponds to a second anode material layer including silicon nanoparticles and sulfide solid state electrolyte and no conductive carbon. A third column 606 corresponds to a conductive additive-free nanosilicon anode material layer including silicon nanoparticles and neither solid state electrolyte nor conductive carbon. As shown in chart 600, removing carbon from the anode material layer may cause a greater initial coulombic efficiency. Elimination of carbon additives from the anode may lead to an increased initial coulombic efficiency value by reducing the concentration of electrons at the interface between the active materials and the solid state electrolyte thereby increasing the kinetic barrier associated with decomposition of the solid state electrolyte. This outcome is surprising at it could not be known if the absence of the carbon would provide the observed benefit or if a less supported electronic percolation network would have led to less reversible exchange of lithium from the silicon during initial charge and discharge cycles.

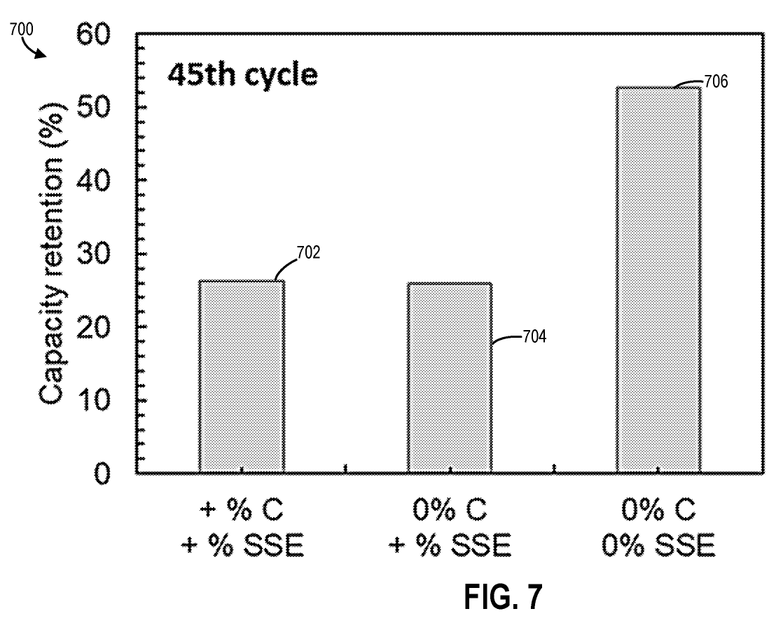

Turning now to FIG. 7, a chart 700 of capacity retention of full cells comprising NCM based cathodes and Si nanoparticles based anodes, at cycle 45, as a function of anode formulation is shown. A first column 702 corresponds to a first anode material layer including silicon nanoparticles, sulfide solid state electrolyte, and conductive carbon. A second column 704 corresponds to a second anode material layer including silicon nanoparticles and sulfide solid state electrolyte and no conductive carbon. A third column 706 corresponds to a conductive additive-free nanosilicon anode material layer including silicon nanoparticles and neither solid state electrolyte nor conductive carbon. It can be seen from third column 706 of FIG. 7 that capacity retained after the full cells are subjected to cycling is higher when the anode formulation comprises a combination of nanosilicon. This indicates that the anode formulation absent of carbon additives and solid state electrolyte accepts and return the lithium inventory from the cathode active materials in a more efficient manner. This result implies that this formulation avoids losses associated with the presence of both carbon or solid electrolyte additives, the presence of which may result in the formation of parasitic phases that irreversibly consume, impede, or consume and impede the inventory and mobility of lithium ions, respectively.

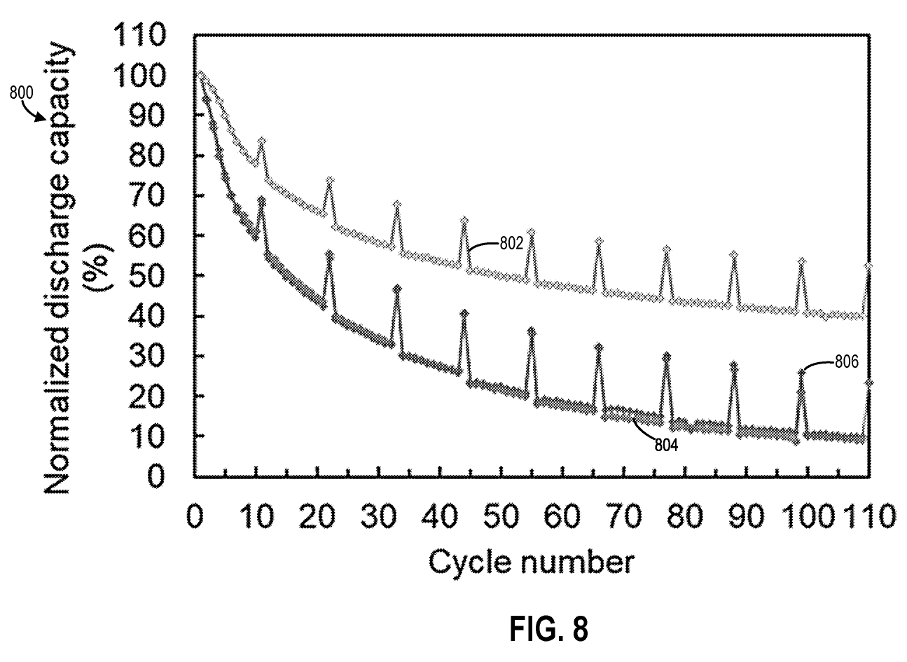

Turning now to FIG. 8, a graph 800 of normalized discharge capacity as a function of cycle number is shown for the full cells. Plot 802 corresponds to normalized discharge capacity of the full cell including the first anode material layer. Plot 804 corresponds to normalized discharge capacity of the full cell including the second anode material layer. Plot 806 corresponds to normalized discharge capacity of the full cell including the conductive additive-free nanosilicon anode material layer. Plot 802 shows a higher normalized discharge capacity than plots 804, and 806 indicating increased capacity retention through 110 cycles for the cell comprising the anode formulation absent of either conducting carbon or solid state electrolyte additives.

The technical effect of method 400 is to form a SS-LIB battery cell including a conductive additive-free nanosilicon anode layer. Lack of conductive additives may increase an energy density of the SS-LIB without demanding stack pressures which are outside of what can be achieved using conventional high throughput manufacturing systems and battery fixtures. It is surprising that the conductive additive-free nanosilicon anode layer results in a battery cell with an improved performance when electronically conductive additives are removed, given the relatively low intrinsic electronic conductivity of silicon. Further, by removing solid state electrolyte from the anode material layer, degradation of the solid state electrolyte by reaction with the silicon anode may be mitigated and formation of the resulting insulating byproducts may be reduced. Additionally, reducing an amount of solid state electrolyte in the anode material layer may reduce a cost of materials.

The disclosure also provides support for a solid state lithium ion battery cell, comprising: an anode material layer including silicon nanoparticles having a diameter less than or equal to 200 nm, wherein a wt.% of the silicon nanoparticles is greater than or equal to 90%, a separator layer including solid state electrolyte, and a cathode material layer. In a first example of the system, the anode material layer is a conductive additive-free anode material layer. In a second example of the system, optionally including the first example, the anode material layer is a solid electrolyte free anode material layer. In a third example of the system, optionally including one or both of the first and second examples, a stack pressure of the solid state lithium ion battery cell is less than or equal to 10 MPa. In a fourth example of the system, optionally including one or more or each of the first through third examples, a porosity of the anode material layer is greater than or equal to 20% in a delithiated state. In a fifth example of the system, optionally including one or more or each of the first through fourth examples, the silicon nanoparticles are roughly spherical. In a sixth example of the system, optionally including one or more or each of the first through fifth examples, the solid state electrolyte is one or more of a sulfide, polymer, oxide, or halide. In a seventh example of the system, optionally including one or more or each of the first through sixth examples, the anode material layer further comprises a binder at wt.% in range of 0.5% to 10%.

The disclosure also provides support for an anode material layer of a solid state lithium ion battery, comprising: silicon nanoparticles having a diameter less than or equal to 200 nm, and binder, wherein the anode material layer is a conductive additive-free anode material layer. In a first example of the system, the diameter of the silicon nanoparticles is less than or equal to 100 nm. In a second example of the system, optionally including the first example, the silicon nanoparticles include a coating, and wherein the coating may be one or more of a polymer coating, carbon coating, metal coating, and metal-oxide coating. In a third example of the system, optionally including one or both of the first and second examples, a wt. % of the binder is in a range of 1% up to 10%. In a fourth example of the system, optionally including one or more or each of the first through third examples, a wt.% of the silicon nanoparticles is in a range of 90% up to 99%. In a fifth example of the system, optionally including one or more or each of the first through fourth examples, a wt. % of the silicon nanoparticles is 95% and a wt.% of the binder is 5%.

The disclosure also provides support for a method of forming a solid state lithium ion battery cell, comprising: mixing an anode slurry including silicon nanoparticles and binder to from an anode material layer, wherein the anode slurry is a conductive additive-free anode slurry, assembling the anode material layer into the solid state lithium ion battery cell, and applying a stack pressure to the solid state lithium ion battery cell, wherein the stack pressure is less than or equal to 10 MPa. In a first example of the method, a diameter of the silicon nanoparticles is less than or equal to 160 nm. In a second example of the method, optionally including the first example, the anode slurry further includes a solvent and a solids loading of the anode slurry is 18 – 70 wt. %. In a third example of the method, optionally including one or both of the first and second examples, mixing the anode slurry occurs in an ambient atmosphere. In a fourth example of the method, optionally including one or more or each of the first through third examples, the stack pressure is less than or equal to 5 MPa. In a fifth example of the method, optionally including one or more or each of the first through fourth examples, applying the stack pressure comprises applying pressure by fixturing of the solid state lithium ion battery cell.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A solid state lithium ion battery cell, comprising:
an anode material layer including silicon nanoparticles having a diameter less than or equal to 200 nm, wherein a wt.% of the silicon nanoparticles is greater than or equal to 90%;
a separator layer including solid state electrolyte; and
a cathode material layer.

2. The solid state lithium ion battery cell of claim 1, wherein the anode material layer is a conductive additive-free anode material layer.

3. The solid state lithium ion battery cell of claim 1, wherein the anode material layer is a solid electrolyte free anode material layer.

4. The solid state lithium ion battery cell of claim 1, wherein a stack pressure of the solid state lithium ion battery cell is less than or equal to 10 MPa.

5. The solid state lithium ion battery cell of claim 1, wherein a porosity of the anode material layer is greater than or equal to 20% in a delithiated state.

6. The solid state lithium ion battery cell of claim 1, wherein the silicon nanoparticles are roughly spherical.

7. The solid state lithium ion battery cell of claim 1, wherein the solid state electrolyte is one or more of a sulfide, polymer, oxide, or halide.

8. The solid state lithium ion battery cell of claim 1, wherein the anode material layer further comprises a binder at wt.% in range of 0.5% to 10%.

9. An anode material layer of a solid state lithium ion battery, comprising:
silicon nanoparticles having a diameter less than or equal to 200 nm; and
binder, wherein the anode material layer is a conductive additive-free anode material layer.

10. The anode material layer of claim 9, wherein the diameter of the silicon nanoparticles is less than or equal to 100 nm.

11. The anode material layer of claim 9, wherein the silicon nanoparticles include a coating, and wherein the coating is one or more of a polymer coating, a carbon coating, a metal coating, and a metal-oxide coating.

12. The anode material layer of claim 9, wherein a wt. % of the binder is in a range of 1% up to 10%.

13. The anode material layer of claim 9, wherein a wt.% of the silicon nanoparticles is in a range of 90% up to 99%.

14. The anode material layer of claim 9, wherein a wt. % of the silicon nanoparticles is 95% and a wt.% of the binder is 5%.

15. A method of forming a solid state lithium ion battery cell, comprising:
mixing an anode slurry including silicon nanoparticles and binder to from an anode material layer, wherein the anode slurry is a conductive additive-free anode slurry;
assembling the anode material layer into the solid state lithium ion battery cell; and
applying a stack pressure to the solid state lithium ion battery cell, wherein the stack pressure is less than or equal to 10 MPa.

16. The method of claim 15, wherein a diameter of the silicon nanoparticles is less than or equal to 160 nm.

17. The method of claim 15, wherein the anode slurry further includes a solvent and a solids content of the anode slurry is 18 wt.% – 70 wt.%.

18. The method of claim 15, wherein mixing the anode slurry occurs in an ambient atmosphere.

19. The method of claim 15, wherein the stack pressure is less than or equal to 5 MPa.

20. The method of claim 15, wherein applying the stack pressure comprises applying pressure by fixturing of the solid state lithium ion battery cell.
